(19) United States
(12) Patent Application Publication
(10) Pub. No.: US 2026/0162325 A1
(43) Pub. Date: Jun. 11, 2026

(54) SYSTEM(S) AND METHOD(S) FOR GENERATIVE MODEL PROCESSING OF IMAGE DATA INCLUDING OBJECT(S) HAVING PARTICULAR FEATURE(S) AND/OR CLASSIFICATION(S)

(71) Applicant: GOOGLE LLC, Mountain View, CA (US)

(72) Inventors: Agoston Weisz, Zurich (CH); Khalid Salama, Zurich (CH); Diana Avram, Zurich (CH)

(21) Appl. No.: 18/970,097

(22) Filed: Dec. 5, 2024

(51) Int. Cl. G06T 11/60; G06T 7/11; G06V 10/44; G06V 10/56; G06V 10/764

(52) U.S. Cl. CPC G06T 11/60; G06T 7/11; G06V 10/44; G06V 10/56; G06V 10/764

(57) ABSTRACT

Implementations relate to systems and methods for controlling generative model processing of image data containing specific objects or classifications. User requests including an image are processed, identifying whether the image includes object(s) with restricted features or classifications. When such object(s) are identified, the image and/or textual description(s) of the image are modified to omit restricted objects. An input prompt for a generative model can be generated based on the modified image and/or the modified textual description(s) of the image, that omit the restricted object(s), ensuring the generated content that is responsive to the request is not generated based on the restricted object(s) and/or omits any mention of the restricted object(s). Implementations maintain data security and/or provide computational efficiencies by selectively excluding certain information from generative model processing.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects NL content and/or other content that is responsive to the input(s). Vision and language models (VLMs) extend LLM capabilities to include the ability to receive images as input in addition to, or as an alternative to, NL input. However, current utilizations of generative models suffer from one or more drawbacks.

To ensure privacy and/or security of data, a user that interacts with a generative model and/or an entity that controls a generative model can restrict the generative model from processing particular types of data. For example, some techniques can fully prevent processing, by a generative model, of any image data (e.g., a raw image and/or derived image data derived from other processing of the raw image) determined to contain an object that has one or more particular features and/or one or more particular classifications.

As one example, VLMs can be utilized as part of a text-based dialogue application, generating responses to queries that comprise images provided by a user of the application. However, a user and/or entity that controls a generative model may restrict the generative model from processing certain image data that includes particular objects that have particular features and/or have particular classifications. Consequently, a response generated by the VLM may lack relevance to the user query, particularly if the user query is directed to elements of the image that the generative model has been restricted from processing.

### SUMMARY

Implementations disclosed herein recognize that in many situations including at least some image data as part of a prompt for a generative model can be beneficial, or even necessary, for resolving a request. For example, if a request provided at a client device pertains to something that is being visually rendered on their client device, at least some image data, that is based on a screenshot of what is being rendered, can be necessary for resolving the request-or can at least reduce a duration of time and/or a quantity of user inputs needed for resolving the request. Accordingly, fully preventing processing of any image data in such a situation can result in computational inefficiencies. As a particular example, assume an image (e.g., screenshot, from a camera, or other image) that captures a computer monitor in part of the image but also captures an object that is separate from the monitor and that is needed for resolving a request. If a generative model is restricted from processing any image data from any image that includes a computer screen (e.g., to ensure privacy and security of any data rendered thereon), this can be detrimental to resolving the request.

Implementations described herein relate to enabling generative model (e.g., LLM and/or VLM) processing of image data, from images that contain an object having particular feature(s) and/or particular classification(s)—while ensuring that the image data that is processed does not characterize the particular feature(s) and/or the particular classification(s) and/or that generative content, generated from such processing, does not characterize the particular feature(s) and/or the particular classification(s). In these and other manners, security and/or privacy of user data is maintained, while still enabling processing of image data for resolving user requests in a more efficient manner.

For example, an image can be provided as an input to a generative model such as an LLM. In some implementations, the generative model can accept only textual input and cannot accept image data as an input. In some of those implementations the image, or data representative thereof, can be provided to one or more image analysis modules (e.g., to server(s) associated with an API) that can process one or more portions of the image to generate textual descriptions of the image. For example, a first image analysis module can process the image and generate textual output that is representative of text that was present in the image data. Additionally and/or alternatively, a second image analysis module can process the image and generate textual output that describes one or more aspects of the image. For example, the second image analysis module can generate textual output that describes one or more objects that are present in the image data. Additionally and/or alternatively, a third image analysis module can cause a search to be performed based on the image and generate textual output that includes text from one or more search results that are responsive to the image based search.

In some implementations, an image can be determined to include an object that has one or more particular features and/or a particular classification that the entity that controls the generative model has restricted the generative model from processing. In response to determining that the image contains the object having one or more of the particular features and/or the particular classification, the object having one or more of the particular features and/or the particular classification can be removed from the image before the image is provided to one or more of the image analysis modules. Additionally and/or alternatively, the image can be partitioned into image segments, and only the segments that do not contain the object having the one or more of the particular features and/or the particular classification can be provided to one or more of the image analysis modules. In some implementations, the object having the one or more particular features and/or the particular classification can be obfuscated prior to providing the image to one or more of the image analysis modules, such that the object having one or more of the particular features and/or the particular classification cannot be processed by one or more of the image analysis modules. The output from one or more of the image analysis modules can be included in an input prompt for the generative model. For example, an input prompt can be constructed that includes such output and that includes any natural language content that is provided along with the image as part of the prompt. The input prompt can then be caused to be processed using a generative model.

Additionally and/or alternatively, the output that is received from one or more of the image analysis modules can be filtered to remove any description of the object having the one or more particular features and/or the particular classification. In these implementations, filtering the output that is received from one or more of the image analysis modules can prevent an input prompt for the generative model from being assembled that includes a description of the object having one or more of the particular features and/or the particular classification. It is noted that in various implementations, filtering the output can be performed in conjunction with implementations that also remove the object, having one or more of the particular features and/or the particular classification, before the image is provided to one or more of the image analysis modules. In those various implementations, filtering can still be beneficial since, in some situations, the output may nonetheless still be descriptive of at least some aspects of the object (e.g., image analysis module(s) may still describe aspect(s) of the object based on processing of surrounding context in the altered image or based on processing of image segment(s) that do not include the object).

In various implementations, the output can be filtered, for example, by processing the output using a generative model (e.g., LLM and/or VLM). The generative model used in processing the output, for filtering, can be separate from the generative model used in processing the output after it has been filtered. For example, the generative model used in processing the output, for filtering, can be stored on the client device that received the request and the processing can occur locally on the client device, while the generative model used in processing the output after it has been filtered can be stored at an additional computing device (e.g., remote server(s)). For instance, a prompt of “if the following content includes any content that directly or indirectly describes [particular feature(s) and/or particular classification(s)] rewrite the content to minimize information loss but to also ensure that it no longer directly or indirectly describes [particular feature(s) and/or particular classification(s)]: following content=[output to filter]” can be generated, with “[output to filter]” being replaced with the output to filter and “[particular feature(s) and/or particular classification(s)]” being replaced with description of the particular feature(s) and/or the particular classification(s). The prompt can be locally processed, using the local generative model, to generate local generative output that reflects rewritten output that removes any description of an object having one or more particular features and/or that has a particular classification.

Additionally and/or alternatively, the output that is received from one or more of the image analysis modules can be filtered by comparing the output to an exclusion list. The exclusion list can include one or more particular features and/or one or more particular classifications that should be filtered from the output that is received from one or more of the image analysis modules before the output is processed using the generative model. Based on the comparison, a mention and/or description of the one or more particular features and/or the one or more particular classifications can be filtered from the output to generate the filtered output.

Filtering the output, that is received from one or more of the image analysis modules, before providing the output to be processed by a generative model in furtherance of resolving a request can improve the security of user data and conserve computational resources. For example, by processing the output that is received from one or more of the image analysis modules to remove a mention and/or description of the one or more particular features and/or the one or more particular classifications, the data including the mention and/or description of the one or more particular features and/or the one or more particular classifications can be prevented from being transmitted to another computing device across a network. By preemptively preventing a mention and/or description of the one or more particular features and/or the one or more particular classifications from being provided as input to the generative model in furtherance of resolving the request, computational resources can be conserved by limiting the amount of processing that must be performed utilizing the generative model to resolve the request. For example, the quantity of tokens that are to be processed utilizing the generative model is reduced by generating output that does not include any description of the one or more particular features and/or the one or more particular classifications. Put another way, in situations where the generative model, used in processing the output after it has been filtered, is remotely stored and the processing of the output after it has been filtered occurs remotely, network usage (in transmitting the filtered output) can be conserved as the filtered output can be of a lesser size than the pre-filtered output and processing resources (in processing a prompt based on the filtered output) can likewise be conserved. Further, in such situations privacy and/or security of data is ensured by preventing any output, that is descriptive of the object having the particular feature(s) and/or the particular classification, from being transmitted over potentially unsecure network channel(s).

In some implementations, the generative model may be a generative model that can be used to process derived image data that textually describes features of the object but that is incapable of processing a raw image (e.g., pixel(s) thereof). In some other implementations, the generative model can be a multi-modal generative model that can be used to process multiple modalities of input such as raw image data and textual input (e.g., textual derived image data and/or other textual input, such as textual input corresponding to a user request) along with the raw image data. In some of those other implementations, in response to determining that an image that is indicated to be applied as input the generative model contains an object having one or more of the particular features and/or the particular classification, the object having one or more of the particular features and/or the particular classification can be removed from the image before the image is processed using the generative model. For example, and as set forth above, the image can be partitioned into image segments, and only the segments that do not contain the object having the one or more of the particular features and/or the particular classification can be processed by the generative model. For instance, one or more pixels that make up the object having one or more of the particular features and/or the particular classification can be removed from the image before the image is processed by the generative model. As another example, the object having the one or more particular features and/or the particular classification can be obfuscated prior to processing the image using the generative model, such that the object having one or more of the particular features and/or the particular classification is not included in the input that is processed by the generative model.

Even in implementations when image data (or data indicative thereof) does not contain an object (or textual description thereof) having one or more of the particular features and/or having a particular classification, including implementations described above where the image data (or data indicative thereof) has been altered to remove an object (or textual description thereof) having one or more of the particular features and/or having the particular classification, in some situations output of a generative model may still include a reference to the object having one or more of the particular features and/or having the particular classification.

In some implementations, in addition to and/or as an alternative to the implementations set forth above, an input prompt can be generated to cause objects, with one more of the particular features and/or the particular classification and that are present in an image input, to be ignored by the generative model. The input prompt can also be generated to cause a textual output of the generative model to exclude any mention of an object having one or more of the particular features and/or the particular classification. Additionally and/or alternatively, the input prompt can be generated to cause a textual output of the generative model to include an indication that image data depicting and/or textual data describing an object having one or more of the particular features and/or the particular classification was not used in generating the textual output. In these and other manners occurrences of output, of the generative model, still including a reference to such an object can be mitigated (e.g., eliminated).

For example, a user may wish to use a generative model to process image data from security cameras and provide the user with natural language summaries of the image data. The user may wish that the natural language summaries not include any descriptions of any animals present in the image data from the security camera because the user does not think that animals are pertinent to the security of the user's home. However, the output generated using the generative model may still include a description that mentions an animal in some situations, even when the generative model was not prompted with any image data containing an animal. For example, if the image data contained a recycling bin that had been knocked over, the output can be “Security Camera One observed a recycling bin that had been knocked over by a racoon”, even though the image data did not include a racoon. An input prompt that includes instructions to not to mention any animals and to ignore any animals contained in the image data can prevent such a response from being generated that includes mention of animal(s). In continuance of the previous example, an input prompt of “if the following content includes any content that directly or indirectly describes animals, rewrite the content to minimize information loss but to also ensure that it no longer directly or indirectly describes animals: [following content]” can result in output that excludes any mention of animals, such as “Security Camera One observed a recycling bin that is laying on its side”.

The preceding is provided as an overview of only some implementations disclosed herein. Those and implementations are described in more detail herein.

### BRIEF DESCRIPTION OF THE DRAWINGS

FIG. 1 depicts an example computing environment according to example implementations of the present disclosure.

FIG. 2 depicts a process flow of an example process using various components from the example environment from FIG. 1, in accordance with various implementations.

FIG. 3 depicts a flowchart illustrating an example method in accordance with various implementations.

FIG. 4 depicts a flowchart illustrating another example method in accordance with various implementations.

FIG. 5 depicts a flowchart illustrating yet another example method in accordance with various implementations.

FIGS. 6A, 6B, and 6C depict an example environment in which techniques described herein may be implemented.

FIG. 7 schematically depicts an example architecture of a computer system.

### DETAILED DESCRIPTION

Implementations described herein relate to restricting generative models from processing content that includes objects that include particular features and/or that have a particular classification. For example, a user request that includes image data can be received at a computing device. When the image data includes one or more objects that have one or more particular features and/or that have a particular classification, the image data can be modified such that a generative model used to process the user request does not process the image data corresponding to the one or more objects having one or more of the particular features and/or having the particular classification(s).

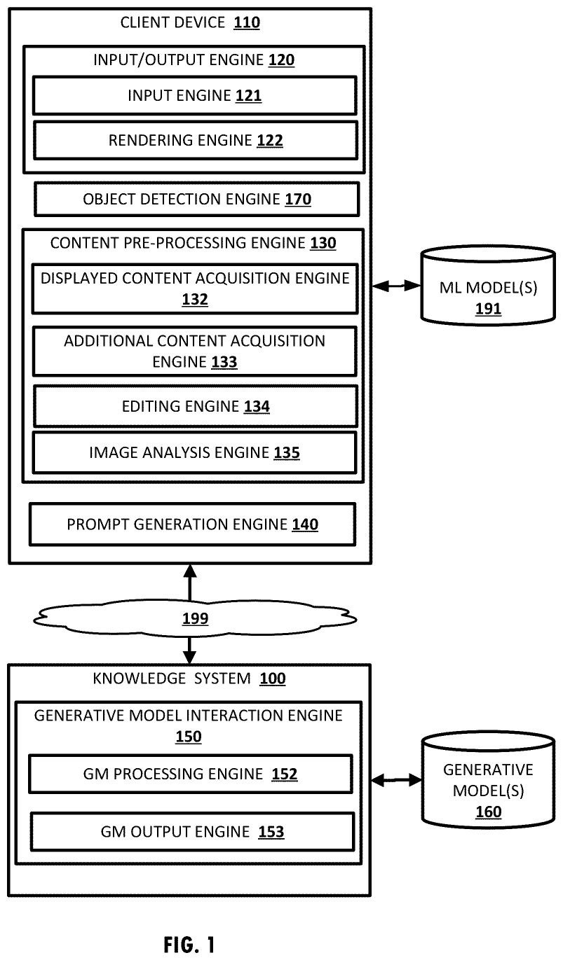

Turning now to FIG. 1, a block diagram of an example environment that demonstrates various aspects of the present disclosure, and in which implementations disclosed herein can be implemented is depicted. The example environment includes a client device 110. In some implementations, aspects of the client device 110 can be implemented remotely from the client device 110 (e.g., at remote server(s)). In those implementations, the client device 110 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet). Additionally and/or alternatively, one or more components of the knowledge system 100 can be implemented on the client device 110.

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications through which touch inputs and/or other user inputs can be submitted and/or content that is responsive to the touch inputs and/or the other user inputs can be rendered (e.g., audibly and/or visually). Notably, the client device 110 can execute one or more of the software applications separately from an operating system of the client device 110 (e.g., one installed “on top” of the operating system), or the client device 110 can execute one or more of the software applications directly by the operating system of the client device 110. For example, the client device 110 can execute a web browser software application, a generative content software application, electronic communications software applications (e.g., email software application(s), messaging software application(s), social media software application(s), etc.), an automated assistant software application, etc. that is installed on top of the operating system of the client device 110. As another example, the client device 110 can execute a web browser software application, a generative content software application, electronic communications software applications (e.g., email software application(s), messaging software application(s), social media software application(s), etc.), an automated assistant software application, etc. that is integrated as part of the operating system of the client device 110.

In various implementations, the client device 110 can include an input/output engine 120 that includes, for example, an input engine 121 and a rendering engine 122. The input engine 121 can be configured to detect input provided, for example, by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110. Additionally, or alternatively, the client device 110 can be equipped with one or more interfaces that are configured to receive content (e.g., document(s), image(s), video(s), audio, etc.) provided by the user of the client device 110.

Additionally, or alternatively, the input engine 121 can process, using automatic speech recognition (ASR) model(s) stored in the ML model(s) database 191 (e.g., a recurrent neural network (RNN) model, a transformer model, and/or any other type of ML model capable of performing ASR), audio data that captures a spoken utterance and that transformed into audio data by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the input engine 121 can select one or more of the speech hypotheses as recognized text that corresponds to the spoken utterance (e.g., based on the corresponding predicted values for each of the speech hypotheses), such as when the input engine 121 utilizes an end-to-end ASR model. In other implementations, the input engine 121 can select one or more of the predicted phonemes (e.g., based on the corresponding predicted values for each of the predicted phonemes), and determine recognized text that corresponds to the spoken utterance based on the one or more predicted phonemes that are selected, such as when the input engine 121 utilizes an ASR model that is not end-to-end. In these implementations, the input engine 121 can optionally employ additional mechanisms (e.g., a directed acyclic graph) to determine the recognized text that corresponds to the spoken utterance based on the one or more predicted phonemes that are selected. In various implementations, generative model(s) described herein can be used to process audio data that captures a spoken utterance without processing of any recognized text generated utilizing a separate ASR model, thereby dismissing with any need for first processing audio data, that captures a spoken utterance, using a separate ASR model.

Further, the rendering engine 122 is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as visual content, such as text, and optionally along with other visual content (e.g., image(s), video(s), etc.), via the client device 110.

In some implementations, the client device 110 can utilize one or more of the ML model(s) stored in the ML model(s) database 191 to process content described herein. For example, and as noted above, the content can be audibly rendered as audible content via the speaker(s) of the client device 110. In these examples, the rendering engine 122 can process content, using text-to-speech (TTS) model(s) stored in the ML model(s) database 191, to generate synthesized speech audio data that includes computer-generated synthesized speech capturing the content. In various implementations, generative model(s) described herein can generate output that reflects synthesized speech directly, dismissing with any need for a separate TTS model.

Further, the client device 110 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The client device 110 is illustrated in FIG. 1 as further including an object detection engine 170 and content preprocessing engine 130. The content pre-processing engine 140 can include a displayed content acquisition engine 132, an additional content acquisition engine 133, an editing engine 134, and an image analysis engine 135.

In various implementations, the object detection engine 170 can be configured to process image data (or data representative thereof) to identify one or more particular objects in the image data that have one or more particular features and/or have a particular classification. For example, the object detection engine 170 can process the image data using one or more machine learning models stored in the ML model(s) database 191 (e.g., a CNN model, a semantic segmentation model, etc.) and/or one or more generative models 160 to identify the one or more particular objects in the image data that have the one or more features and/or have the particular classification.

In some implementations, the displayed content acquisition engine 132 can capture content that is currently displayed at a computing device (e.g., at the client device 110). For example, the displayed content acquisition engine 132 can capture a screenshot and/or a screen recording of content that is currently presented at a display of the client device 110.

In some implementations, the additional content acquisition engine 133 can acquire content that may not be currently rendered at the client device 110. For example, the additional content acquisition engine 133 can acquire content from a camera of the client device 110. Additionally and/or alternatively, the additional content acquisition engine 133 can acquire image data that is stored either locally at the client device 110, or stored on one or more other computing devices and is accessible to the client device 110 over the network(s) 199. For example, the image data can be stored at an application of the client device 110 and/or in one or more message threads accessible via the client device 110. The additional content acquisition engine 133 can additionally and/or alternatively acquire content from one or more webpages. For example, the additional content acquisition engine 133 can acquire image data from one or more webpages that a user has previously visited. Additionally and/or alternatively, the additional content acquisition engine 133 can acquire image data from one or more cameras that the client device 110 is communicatively coupled with. For example, one or more security cameras that are accessible via the client device 110 (e.g., via the network(s) 199) and/or one or more other devices that are associated with and/or accessible by the client device 110.

The editing engine 134 can be used to alter the image data (or data representative thereof) to obfuscate and/or edit the image data (or data representative thereof) such that it does not identify one or more objects in the image data that have one or more particular features and/or have a particular classification. For example, the editing engine 134 can be used to obfuscate image data by altering RGB pixel values and/or HSL pixel values of the image data to render the one or more objects as illegible. For instance, for each of the pixels that are determined to correspond to an object in the image, they can be set to the same pixel values. As a particular instance, for an RGB image each of the pixels determined to correspond to an object in the image can have a same first value for the red channel, a same second value for the green channel, and a same third value for the blue channel.

Additionally and/or alternatively, the editing engine 134 can partition the image data into one or more segments and generate updated image data that excludes one or more of the segments. The one or segments that can be excluded from the updated image data can include objects having one or more of the particular features and/or having the particular classification.

In various implementations, the generative model(s) 160 used in processing the request may not be capable of processing image data that is associated with the request. The image analysis engine 135 can process the image data and generate textual output that is representative of the image data. For example, the image analysis engine 135 can generate textual output that describes one or more objects in the image data and/or is a textual representation of text that is present in the image data. In some implementations, the image analysis engine 135 can cause a search to be performed based on the image and generate textual output that includes text from one or more search results that are responsive to the image based search

The editing engine 134 can parse the output of the image analysis engine 135 to remove and/or filter any mention, description, and/or other representation of one or more objects that have one or more particular features and/or have a particular classification. In some implementations, the output of the image analysis engine 135 can be filtered, for example, by processing the output using a generative model (e.g., LLM and/or VLM). The generative model used in processing the output, for filtering, can be separate from the generative model used in processing the output after it has been filtered. For example, the generative model used in processing the output can be stored on the client device that received the request and processing using that generative model can occur on the client device, while the generative model used in processing the output after it has been filtered can be stored at an additional computing device and processing using that generative model can occur at the additional computing device.

In various implementations, the client device 110 can additionally and/or alternatively include a prompt generation engine 140. The prompt generation engine 140 can be configured to generate input prompts for generative models based on the request and the image data. For example, the prompt generation engine 140 can generate an input prompt based on the textual output that is generated by the image analysis engine 135 and the request. The prompt generation engine 140 can generate an input prompt, for a generative model, that includes image data that has been altered by the editing engine 134. Additionally and/or alternatively, the prompt generation engine 140 can generate a prompt that will cause output of the generative model to omit any description, mention, and/or reference of one or more objects having one or more particular features and/or having a particular classification.

FIG. 1 depicts the client device 110 as being communicatively coupled with a knowledge system 100 via one or more of the network(s) 199. The knowledge system 100 can include a generative model interaction engine 150. The generative model interaction engine 150 can include a generative model processing engine 152 and/or a generative model output engine 153. The generative model interaction engine can have access to one or more generative models 160.

The input prompt generated by the prompt generation engine 140 can be processed by the generative model processing engine 152 using one or more generative models 160. Once the generative model processing engine 152 has processed the input prompt using one or more of the generative models 160, the generative model output engine 153 can receive the output that was generated using the generative model 160.

In various implementations, the output can be provided to the rendering engine 122 of the client device 110. The rendering engine can visually render output via one or more displays of the client device 110. Additionally and/or alternatively, the rendering engine 122 can audibly render output via one or more speakers associated with the client device, such as internal speakers or headphones connected to the client device 110. While FIG. 1 is depicted having various components executing on the client device and various other components executing within a knowledge system 100 that is separate from the client device 110, it should be understood that is for the sake of example and is not meant to be limiting. For example, one or more of the components depicted in FIG. 1 as executing on the client device 110 may alternatively be implemented at the knowledge system 100. Additionally and/or alternatively, one or more of the components depicted in FIG. 1 as executing at the knowledge system 100 may alternatively be implemented at the client device 110. Furthermore, many of the components discussed in FIG. 1 may function in the same or similar fashion in a distributed computing environment, such as in the network(s) 199.

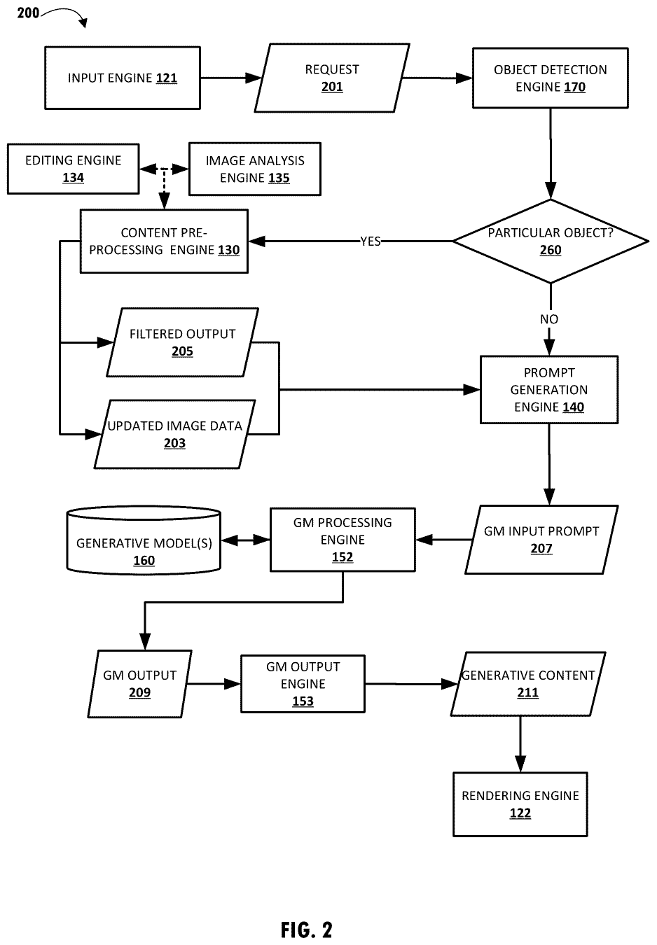

FIG. 2 depicts a process flow of an example process using various components from the example environment from FIG. 1, in accordance with various implementations. For convenience, the process 200 will be described with reference to FIG. 1. The process 200 begins when the input engine 121 receives input. The input received at the input engine 121 can be, for example, an unstructured natural language input (e.g., typed input) and/or a free-form natural language input (e.g., spoken input). The input received at the input engine 121 can be, for example, generated by an assistant engine and/or application executing at the client device 110. For example, the input received at the input engine 121 can be received in response to and/or based on an assistant engine executing at the client device 110 determining that the input corresponds to a task that the assistant engine and/or application executing at the client device 110.

The input can correspond to a request 201. The request 201 can be a user request that includes one or more user inputs. For example, a user of the client device 110 can provide one or more natural language (e.g., spoken, written, etc.) user inputs at a user interface of the client device 110 that corresponds to the request 201. Additionally and/or alternatively, the request 201 can be provided by an additional computing device. For example, a computing device that implements a security system may send periodic requests 201 to process image data captured by the cameras of the security system. The time between each request 201 can be uniform, or can be dynamically determined by the computing device that is sending the request 201.

In some implementations, the request 201 can include image data, or data representative of one or more images. At least the portion of the request 201 that includes the image data can be processed by the object detection engine 170. By processing the image data using the object detection engine 170, it can be determined at decision block 260 whether the image data includes one or more particular objects that have one or more particular features and/or have a particular classification.

In implementations when it is determined at decision block 260 that the image data does not include one or more particular objects that have one or more of the particular features and/or have the particular classification, the process 200 continues to the prompt generation engine 140. In those implementations, the prompt generation engine 140 can generate a generative model input prompt 207 based on the image data (e.g., raw pixels thereof and/or natural language descriptions thereof) and without utilization of any of the techniques disclosed herein for preventing content, descriptive of object(s) having particular feature(s) and/or particular classification(s), from being included in the prompt. Put another way, in those implementations, the decision block 260 can be utilized to determine whether extra processing is needed to ensure privacy and/or security of data and, if so, perform such extra processing. However, if not, such extra processing is bypassed thereby conserving needless extra processing.

In implementations when it is determined at decision block 260 that the image data does include one or more particular objects that have one or more of the particular features and/or have the particular classification, the process 200 continues to the content pre-processing engine 130.

The content pre-processing engine 130 can utilize the image analysis engine 135 and the editing engine 134 to process the image data. For example, the image analysis engine 135 can process the image data to generate textual output that describes one or more objects in the image data and/or is a textual representation of text that is present in the image data. Additionally and/or alternatively, the editing engine 134 can parse the output of the image analysis engine 135 to generate filtered output 205. In generating the filtered output 205, the editing engine 134 can remove and/or filter any mention, description, and/or other representation of one or more objects that have one or more particular features and/or have a particular classification from the textual output. For example, the output of the image analysis engine 134 can be provided (e.g., included as part of a prompt) for processing, using a generative model, to remove any mention, description, and/or other representation of one or more objects that have one or more particular features and/or have a particular classification from the textual output.

In some implementations, the editing engine 134 can optionally process the image data to generate updated image data 203. In generating the updated image data 203, the editing engine 134 can remove and/or obfuscate one or more objects that have one or more of the particular features and/or have the particular classification in the image data. For example, the editing engine 134 can alter RGB pixel values of the image data to render the one or more objects having one or more of the particular features and/or having the particular classification as illegible. Additionally and/or alternatively, the editing engine 134 can partition the image data into one or more segments and generate updated image data 203 that excludes one or more of the segments. The one or segments that can be excluded from the updated image data 203 can include objects having one or more of the particular features and/or having the particular classification.

In various implementations, the updated image data 203 and/or the filtered output 205 can be provided to the prompt generation engine 140. For example, in implementations when the generative model(s) 160 used in processing the request 201 is not capable of processing image data, the prompt generation engine 140 can generate a generative model input prompt 207 based on the filtered output 205 and/or the request 201. Alternatively, in implementations when the generative model(s) 150 used in processing the request 201 is capable of processing image data, the prompt generation engine 140 can generate a generative model input prompt 207 based on the updated image data 203 and/or the request 201.

The generative model input prompt 207 can be provided to the generative model processing engine 152. The generative model processing engine 152 can process the generative model input prompt 207 using one or more of the generative models 150 to generate generative model output 209. The generative model output 209 can include, for example, a probability distribution over a sequence of tokens. The sequence of tokens can correspond to, for instance, candidate suggestions for responses to the request 201. Alternatively and/or additionally, the sequence of tokens can correspond to candidate suggestions for actions that are performable responsive to the request 201.

The generative model output 209 can be provided to the generative model output engine 153, which can generate generative content 211 based on the generative model output 209. The generative model output engine 153 can utilize various decoding techniques to process the generative model output 209. For example the generative model output engine 153 can process the generative model output 209 and generate generative content 211 that is a natural language response to the request 201. Additionally and/or alternatively, the generative model output engine 153 can process the generative model output 209 and generate generative content 211 that includes instructions that cause one or more computing devices to perform one or more actions in response to the request 201.

In some implementations, the generative content 211 can be provided to the rendering engine 122 of the client device 110. The rendering engine can visually render output via one or more displays of the client device 110 that corresponds to the generative content 211. Additionally and/or alternatively, the rendering engine 122 can cause one or more speakers associated with the client device 110 to audibly render content that corresponds to the generative content 211.

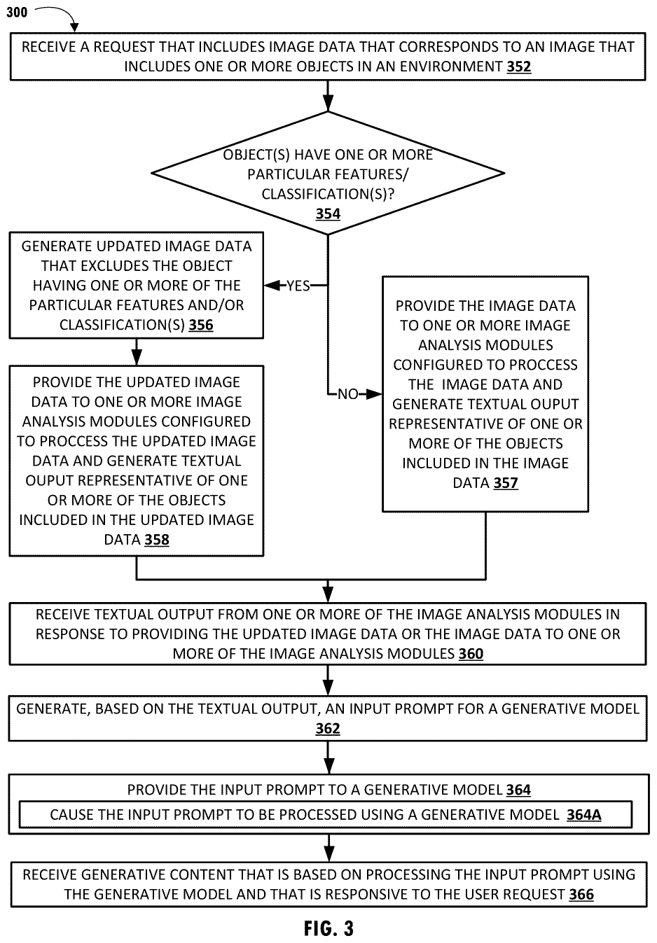

FIG. 3 depicts a flowchart illustrating an example method 300 in accordance with various implementations. For convenience, the operations of the flow chart are described with reference to a system that performs the operations. The system of method 300 includes at least one processor, memory, and/or other component(s) of computing device(s). Moreover, while the operations of the method 300 are shown in a particular order, this is not meant to be limiting. One or more operations may be reordered, omitted, and/or added.

At block 352, the system receives a request. The request can include image data corresponding to an image that includes one or more objects in an environment. For example, a user can submit the request via one or more input devices (e.g., a keyboard, microphone, camera, and/or touchscreen of a computing device). Alternatively and/or additionally, the request can be received from a computing device in furtherance of performing an action. For example, a security system can periodically request that image data captured by the security system be processed and summarized.

In some implementations, the user request can include one or more textual inputs in addition to the image data. The textual inputs can be provided by a user directly via a keyboard of the computing device, can be generated by a speech-to-text engine of the computing device that converts audio data corresponding to spoken words of the user into one or more textual inputs, and/or can be generated by a computing device. The image data can be an image (e.g., one or more pixels and/or one or more files that encode the image) that the user has access to. For example, the image data can be a screenshot and/or screen recording, a photo and/or a video captured by a camera of a computing device, a live video and/or photograph that is currently being rendered by a computing device, a photo and/or video that is stored locally at a computing device and/or remotely stored (e.g., at a remote storage device); and/or any other type of image data that the computing device has access to. In various implementations, the image data can be textual data that corresponds to one or more images accessible to the computing device.

At decision block 354 the system determines, based on the image data, whether a particular object, of the one or more objects, includes one or more particular features and/or a particular classification. For example, the image data can be processed to determine whether the image data includes at least one object that has one or more particular features and/or has a particular classification that the entity that controls the generative model and/or the entity that is using the generative model has restricted the generative model from processing. The classifications can be categorical groups to which several objects can be assigned. For example, a classification of ‘documents’ can include all media that has text and/or images transcribed therein. Additionally and/or alternatively, features can be a particular attribute of one or more objects. For example, an object that has a classification of ‘document’ can have particular features of text and/or images that are included in the document.

If the system determines at decision block 354 that the image data does not include at least one object with one or more particular features and/or a particular classification, the image data can be provided to one or more image analysis modules at block 357. The image analysis modules can be configured to process the image data to generate textual output that is representative of the image data. For example, one image analysis module can be configured to process the image data and generate textual output that represents text included in the image data. Additionally and/or alternatively, another image analysis module can be configured to process the image data and generate textual output that describes objects in the image data. Yet another image analysis module can be configured to cause a search to be performed based on the image and generate textual output that includes text from one or more search results that are responsive to the image based search. The image analysis modules can be one or more natural language processing engines, optical character recognition engines, image recognition engines, and/or any other type of image processing module.

At block 356, the system, in response to determining, at decision block 354, that the image data includes an object that has one or more of the particular features and/or has the particular classification, can generate updated image data that excludes the particular object. For example, the updated image data can be generated and/or can be altered to remove at least part of the particular object that has one or more of the particular features and/or a particular classification. In some implementations, all of the particular object that has one or more of the particular features and/or the particular classification can be removed from the image data to generate the updated image data. For example, one or more pixels of the particular object that has one or more of the particular features and/or the particular classification can be altered in the image data to generate the updated image data.

For instance, RGB pixel values can be altered such that the particular object that has one or more of the particular features and/or the particular classification are no longer visible in the image data. Alternatively and/or additionally, the image data can be partitioned into segments. One or more of the segments that include the particular object that has one or more of the particular features and/or the particular classification can be excluded from the updated image data. In some implementations, the particular object that has one or more of the particular features and/or the particular classification can be obfuscated when the updated image data is generated such that the particular object having one or more of the particular features and/or the particular classification cannot be detected in the updated image data. In various implementations, text in the image data corresponding to the particular object that has one or more of the particular features and/or the particular classification can be removed when the updated image data is generated.

At block 358, the system provides the updated image data to one or more image analysis modules. One or more of the image analysis modules can be configured to process the updated image data to generate textual output that is representative of one or more of the objects included in the updated image data. For example, a first image analysis module can be configured to process the updated image data and generate textual output that represents text included in the updated image data. Additionally and/or alternatively, a second image analysis module can be configured to process the updated image data and generate textual output that describes one or more objects in the updated image data. Yet another image analysis module can be configured to cause a search to be performed based on the image and generate textual output that includes text from one or more search results that are responsive to the image based search. The image analysis modules can be one or more natural language processing engines, optical character recognition engines, image recognition engines, and/or any other type of image processing module.

At block 360 the system receives, in response to providing the updated image data to one or more of the additional computing devices and from one or more of the additional computing devices, the textual output that is representative of one or more of the objects included in the updated image data. For example, the textual output that is received can be a natural language description of one or more objects included in the image data and/or the updated image data. Additionally and/or alternatively, the textual output can be a natural language description of text that is included in the image data and/or the updated image data.

At block 362, the system generates, based on the textual output received from one or more of the additional computing devices, an input prompt for a generative model. In some implementations, the input prompt may include at least a portion of the textual output that is representative of one or more objects included in the updated image data

In various implementations, the input prompt can be generated to cause output of the generative model to omit a representation of the one or more objects that have one or more of the particular features and/or have the particular classification. For example, a prompt of “if the following content includes any content that directly or indirectly describes [particular feature(s) and/or particular classification(s)] rewrite the content to minimize information loss but to also ensure that it not longer directly or indirectly describes [particular feature(s) and/or particular classification(s)]” can be applied as input to the generative model along with the at least a portion of the textual output to filter the output to remove any description of an object having one or more particular features and/or has a particular classification. Additionally and/or alternatively, the input prompt can be generated to cause a textual output of the generative model to include an indication that image data depicting and/or textual data describing an object having one or more of the particular features and/or the particular classification was not used in generating the textual output.

At block 364, the system provides the input prompt to the generative model. Providing the input prompt to the generative model can include (e.g., consist of) causing the input prompt to be processed using the generative model in block 364A to generate generative content that is responsive to the request. The generative content can be a natural language response to the request, a multimodal response to the request (e.g., that includes natural language and image(s)), instructions that cause one or more computing devices to perform one or more actions in furtherance of the request, audible and/or visual content that is responsive to the request, and/or any other generated content that is responsive to the request.

At block 366, the system receives the generative content that is based on processing the input prompt using the generative model and that is responsive to the request. Receiving the generative content that is responsive to the request can cause the generative content to be provided in response to the request. Providing the generative content in response to the request can include visually rendering the generative content, for example, via one or more displays of a computing device. Additionally and/or alternatively, the generative content can be rendered audibly, for example, via one or more speakers of a computing device. The computing device that renders the generative content can be the computing device that received the request and/or an additional computing device.

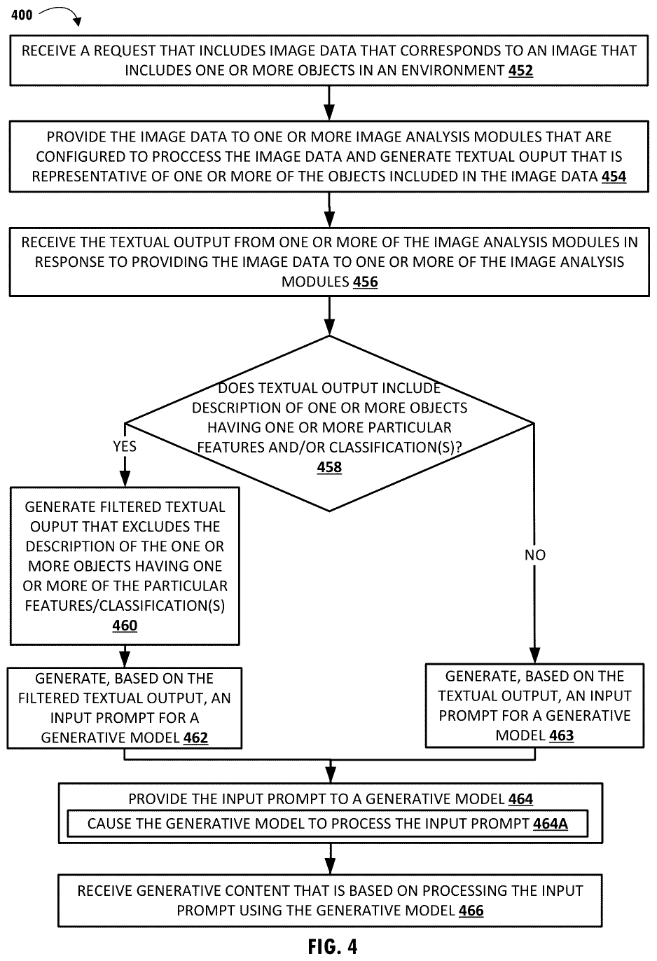

Turning now to FIG. 4, a flowchart is depicted that illustrations another example method 400 in accordance with various implementations. For convenience, the operations of the flow chart are described with reference to a system that performs the operations. The system of method 400 includes at least one processor, memory, and/or other component(s) of computing device(s). Moreover, while the operations of the method 400 are shown in a particular order, this is not meant to be limiting. One or more operations may be reordered, omitted, and/or added.

At block 452, the system receives a request that includes image data. For example, a user can submit the request via one or more input devices (e.g., a keyboard, microphone, camera, and/or touchscreen of a computing device). Alternatively and/or additionally, the request can be received from a computing device in furtherance of performing an action. For example, a security system can periodically request that image data captured by the security system be processed and summarized.

In some implementations, the request can include one or more textual inputs in addition to the image data. The textual inputs can be provided by a user directly via a keyboard of the computing device, can be generated by a speech-to-text engine of the computing device that converts audio data corresponding to spoken words of the user into one or more textual inputs, and/or can be generated by a computing device. The image data can be an image (e.g., one or more pixels and/or one or more files that encode the image) that the user has access to. For example, the image data can be a screenshot and/or screen recording, a photo and/or a video captured by a camera of a computing device, a live video and/or photograph that is currently being rendered by a computing device, a photo and/or video that is stored locally at a computing device and/or remotely stored (e.g., at a remote storage device); and/or any other type of image data that the computing device has access to. In various implementations, the image data can be textual data that corresponds to one or more images accessible to the computing device.

At block 454 the system provides the image data to one or more image analysis modules. The image analysis modules can be configured to process the image data to generate textual output that is representative of the image data, including one or more objects in the image data. For example, one image analysis module can be configured to process the image data and generate textual output that represents text included in the image data. Additionally and/or alternatively, another image analysis module can be configured to process the image data and generate textual output that describes objects in the image data. Yet another image analysis module can be configured to cause a search to be performed based on the image and generate textual output that includes text from one or more search results that are responsive to the image based search. The image analysis modules can be one or more natural language processing engines, optical character recognition engines, image recognition engines, and/or any other type of image processing module.

At block 456, the system receives, in response to providing the image data to one or more of the image processing modules, the textual output that is representative of the image data, including one or more of the objects included in the image data. For example, the textual output that is received can be a natural language description of one or more objects included in the image data. Additionally and/or alternatively, the textual output can correspond to text that was included in the image data.

At decision block 458, the system determines whether the textual output received from one or more of the image analysis modules includes a description of one or more of the objects that have one or more of the particular features and/or have the particular classification. The description can include a mention, a reference, an attribution, and/or any other representation of an object that has one or more of the particular features and/or has the particular classification.

If the system determines at decision block 458 that the textual output received from one or more of the image analysis modules does not include a description of one or more of the objects that have one or more of the particular features and/or have the particular classification, the system can, at block 463, generate an input prompt for a generative model based on the textual output that was received from one or more of the image analysis modules.

If the system determines at decision block 458 that the textual output received from one or more of the image analysis modules does include a description of one or more of the objects that have one or more of the particular features and/or have the particular classification, the system can, at block 460, generate filtered textual output that excludes the description of one or more of the objects that have one or more of the particular features and/or have the particular classification. The filtered textual output can correspond to the textual output that was received from one or more of the image analysis modules, except that the filtered textual output excludes the description(s) of one or more of the objects that have one or more of the particular features and/or have the particular classification. Additionally and/or alternatively, the filtered textual output can be a summary of the textual output that omits descriptions of objects that have one or more of the particular features and/or have the particular classification. For example, a generative model can be used to process the textual output and generate filtered textual output that excludes the description(s) of one or more of the objects that have one or more of the particular features and/or have the particular classification. The generative model can be an on-device generative model such that the egress of data from the client device is prevented.

At block 462, the system can generate an input prompt for a generative model based on the filtered textual output. In some implementations, the input prompt may include at least a portion of the filtered textual output. In various implementations, the input prompt can be generated to cause output of the generative model to omit a representation of the one or more objects that have one or more of the particular features and/or have the particular classification. For example, a prompt of “if the following content includes any content that directly or indirectly describes [particular feature(s) and/or particular classification(s)] rewrite the content to minimize information loss but to also ensure that it no longer directly or indirectly describes [particular feature(s) and/or particular classification(s)]” can be applied as input to the generative model along with the at least a portion of the filtered textual output to remove any description of an object having one or more particular features and/or has a particular classification from the output of the generative model. Additionally and/or alternatively, the input prompt can be generated to cause a textual output of the generative model to include an indication that image data depicting and/or textual data describing an object having one or more of the particular features and/or the particular classification was not used in generating the textual output of the generative model.

At block 464, the system provides the input prompt to the generative model. Providing the input prompt to the generative model can include causing the input prompt to be processed using the generative model in block 464A to generate generative content that is responsive to the request. The generative content can be a natural language response to the request, instructions that cause one or more computing devices to perform one or more actions in furtherance of the request, audible and/or visual content that is responsive to the request, and/or any other generated content that is responsive to the request.

At block 466, the system receives the generative content that is based on processing the input prompt using the generative model and that is responsive to the request. Receiving the generative content that is responsive to the request can cause the generative content to be provided in response to the request. Providing the generative content in response to the request can include visually rendering the generative content, for example, via one or more displays of a computing device. Additionally and/or alternatively, the generative content can be rendered audibly, for example, via one or more speakers of a computing device. The computing device that renders the generative content can be the computing device that received the request and/or an additional computing device.

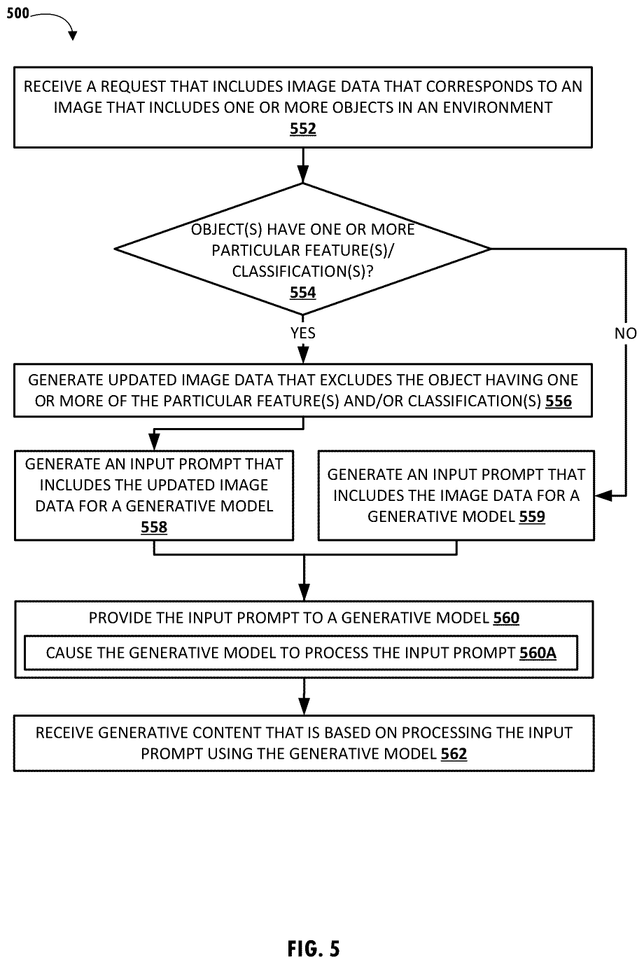

Turning now to FIG. 5, a flowchart is depicted that illustrates yet another example method 500 in accordance with various implementations. For convenience, the operations of the flow chart are described with reference to a system that performs the operations. The system of method 500 includes at least one processor, memory, and/or other component(s) of computing device(s). Moreover, while the operations of the method 500 are shown in a particular order, this is not meant to be limiting. One or more operations may be reordered, omitted, and/or added.

At block 552, the system receives a request that includes image data. The image data can include one or more objects in an environment. For example, a user can submit the request via one or more input devices (e.g., a keyboard, microphone, camera, and/or touchscreen of a computing device). Alternatively and/or additionally, the request can be received from a computing device in furtherance of performing an action. For example, a security system can periodically request that image data captured by the security system be processed and summarized.

In some implementations, the request can include one or more textual inputs in addition to the image data. The textual inputs can be provided by a user directly via a keyboard of the computing device, can be generated by a speech-to-text engine of the computing device that converts audio data corresponding to spoken words of the user into one or more textual inputs, and/or can be generated by a computing device. The image data can be an image (e.g., one or more pixels and/or one or more files that encode the image) that the user has access to. For example, the image data can be a screenshot and/or screen recording, a photo and/or a video captured by a camera of a computing device, a live video and/or photograph that is currently being rendered by a computing device, a photo and/or video that is stored locally at a computing device and/or remotely stored (e.g., at a remote storage device); and/or any other type of image data that the computing device has access to. In various implementations, the image data can be textual data that corresponds to one or more images accessible to the computing device.

At decision block 554 the system determines, based on the image data, whether a particular object of the one or more objects included in the image data has one or more particular features and/or a particular classification. For example, the image data can be processed to determine whether the image data includes at least one object that has one or more particular features and/or a particular classification that the entity that controls the generative model and/or the entity that is using the generative model has restricted the generative model from processing. The classifications can be categorical groups to which several objects can be assigned. For example, a classification of ‘documents’ can include all media that has text and/or images transcribed therein. Additionally and/or alternatively, features can be a particular attribute of one or more objects. For example, an object that has a classification of ‘document’ can have particular features of text and/or images that are included in the document.

If the system determines at decision block 554 that the image data does not include at least one object with one or more particular features and/or a particular classification, the system can, at block 559, generate an input prompt for a generative model based on the image data. For example, the input prompt can be based on the image data and not based on any updated image data that excludes the particular feature(s) and/or classification(s). For instance, the input prompt can be generated without performing block 556 and without performing block 558.

If the system determines at decision block 554 that the image data includes an object that has one or more of the particular features and/or has the particular classification, the system can, at block 556, generate updated image data that excludes the particular object that has one or more of the particular features and/or has the particular classification. For example, the updated image data can be generated and/or can be altered to remove and/or obfuscate at least part of the particular object that has one or more of the particular features and/or has the particular classification. In some implementations, all of the particular object that has one or more of the particular features and/or the particular classification can be removed and/or obfuscated from the image data to generate the updated image data. For example, one or more pixels of the particular object that has one or more of the particular features and/or the particular classification can be altered in the image data to generate the updated image data. For instance, RGB pixel values can be altered such that the particular object that has one or more of the particular features and/or the particular classification are no longer visible in the image data. In various implementations, text in the image data corresponding to the particular object that has one or more of the particular features and/or the particular classification can be removed and/or obfuscated when the updated image data is generated. Alternatively and/or additionally, the image data can be partitioned into segments. One or more of the segments that include the particular object that has one or more of the particular features and/or the particular classification can be excluded from the updated image data.

At block 558, the system can generate an input prompt for a generative model based on the updated image data. In some implementations, the input prompt may include at least a portion of the updated image data. In various implementations, the input prompt can be generated to cause output of the generative model to omit a representation of the one or more objects that have one or more of the particular features and/or have the particular classification. For example, a prompt of “if the following content includes any content that directly or indirectly describes [particular feature(s) and/or particular classification(s)] rewrite the content to minimize information loss but to also ensure that it not longer directly or indirectly describes [particular feature(s) and/or particular classification(s)]” can be applied as input to the generative model along with the at least a portion of the updated image data to filter the output of the generative model to remove any description of an object having one or more particular features and/or has a particular classification. Additionally and/or alternatively, the input prompt can be generated to cause an output of the generative model to include an indication that image data depicting and/or textual data describing an object having one or more of the particular features and/or the particular classification was not used in generating the textual output of the generative model.

At block 560, the system provides the input prompt to the generative model. Providing the input prompt to the generative model can include causing the input prompt to be processed using the generative model in block 560A to generate generative content that is responsive to the request. The generative content can be a natural language response to the request, instructions that cause one or more computing devices to perform one or more actions in furtherance of the request, audible and/or visual content that is responsive to the request, and/or any other generated content that is responsive to the request.

At block 562, the system receives the generative content that is based on processing the input prompt using the generative model and that is responsive to the request. Receiving the generative content that is responsive to the request can cause the generative content to be provided in response to the request. Providing the generative content in response to the request can include visually rendering the generative content, for example, via one or more displays of a computing device. Additionally and/or alternatively, the generative content can be rendered audibly, for example, via one or more speakers of a computing device. The computing device that renders the generative content can be the computing device that received the request and/or an additional computing device.

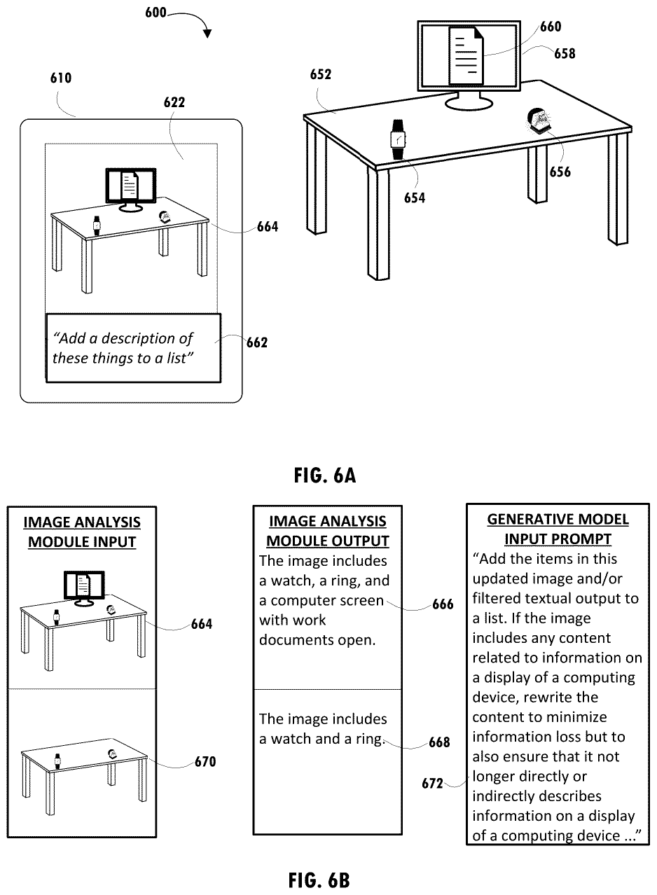

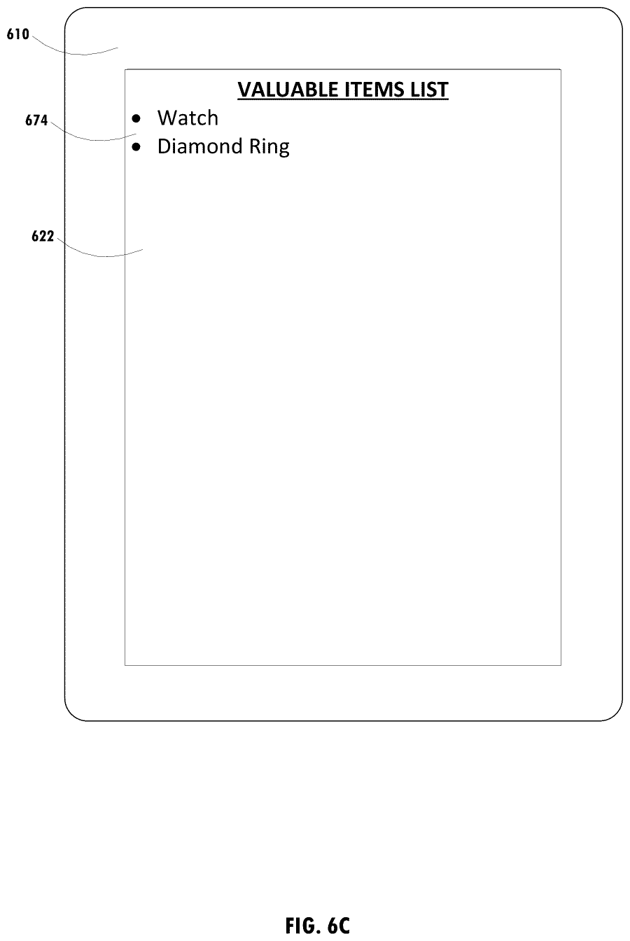

Turning now to FIGS. 6A, 6B, and 6C, various non-limiting examples of enabling generative model (e.g., LLM, VLM, and/or other generative model(s)) processing of image data, from images that contain an object having particular feature(s) and/or particular classification(s)—while ensuring that the image data that is processed does not characterize the particular feature(s) and/or the particular classification(s) and/or that generative content, generated from such processing, does not characterize the particular feature(s) and/or the particular classification(s) are depicted. A client device 610 (e.g., the client device 110 from FIG. 1) may include various user interface components including, for example, microphone(s) to generate audio data based on spoken utterances and/or other audible input, speaker(s) to audibly render synthesized speech and/or other output, a display 622 to visually render visual output, and/or one or more input devices such as a keyboard that can receive input from a user.

Specifically referring now to FIG. 6A, an environment 600 can include a desk 652. The desk 652 can include several objects placed on top of the desk 652. For example, a watch 654, a ring 656, and a computer monitor 658 can all be placed on top of the desk 652. The computer monitor 658 can be displaying one or more documents 660, such as documents 660 for work. A user can provide a request 662, such as “Add a description of these things to a list.” The request 662 can include image data 664. The image data 664 can be a depiction of the environment 600. For example, the image data can include the watch 654, the ring 656, and the computer monitor 658 that has the documents 660 displayed. The request 662 can indicate that a user wants to catalog the objects in the image data 664. However, the user and/or the entity that controls the generative model that will be used in processing the request 662 can restrict the generative model from being used in processing particular types of content. For example, a user may not want the generative model to be used in processing any type of information displayed on the computer monitor 658.

Referring now to FIG. 6B, the request 662 that includes the image data 664 can be processed to provide generative content that is response to the request 662 while ensuring that the image data that is processed by the generative model does not include any object that has one or more of the particular features and/or has the particular classification.

For example, and as described above with respect to FIGS. 1, 2, 3, and 4, some generative models may not be capable of processing image data 664. The image data 664 can be provided as input to one or more image analysis modules to generate textual output 666 that is representative of the image data 664. The textual output 666 can be further filtered to remove descriptions of the computer monitor 658 and the documents 660 that are displayed on the computer monitor 658. The result of the filtering can be the filtered textual output 668, which excludes any mention and/or description of the computer monitor 658 and/or the documents 660 displayed on the computer monitor 658. The filtered textual output 668 can be used to generate at least a portion of an input prompt 672 for one or more generative models.

In some implementations, the image data 664 can be modified prior to being provided to one or more of the image analysis modules. For example, using the techniques described above, updated image data 670 can be generated that omits the object that has one or more of the particular features and/or has the particular classification (e.g., the computer monitor 658 and the documents 660 that are displayed on the computer monitor 658). The updated image data 670 can be provided to one or more of the image analysis modules. One or more of the image analysis modules can process the updated image data 670 to generate the filtered textual output 668. When the image data 664 is modified to generate the updated image data 670, the resulting filtered textual output 668 can be generated without having to process the textual output 666 to remove any mention and/or description of the objects that have one or more of the particular features and/or have the particular classification. The filtered textual output 668 can then be used in generating at least a portion of an input prompt 672 for a generative model.

In some implementations, the generative model(s) used in processing the request 662 may be capable of processing the image data 664. In such implementations, the updated image data 670 can be provided to the generative model as at least a portion of an input prompt 672.

In various implementations, the input prompt 672 can be generated to prevent any representation of the one or more objects that have one or more of the particular features and/or have the particular classification from being included in the output of the generative model. For example, the input prompt 672 can state “Add the items in this updated image 670 and/or filtered textual output 668 to a list. If the image includes any content related to information on a display of a computing device, rewrite the content to minimize information loss but to also ensure that it no longer directly or indirectly describes information on a display of a computing device . . . . ”

Turning now to FIG. 6C, the result of processing the request 662 that includes the image data 664 using the techniques described above is depicted. Processing the input prompt 672 using the one or more generative models can result in the generative content 674 being provided in response to the request 662. The generative content 674 can exclude any mention and/or description of the objects that have one or more of the particular features and/or have the particular classification. For example, the generative content 674 depicted in FIG. 6C is a list that excludes any mention of the computer monitor 658 and the documents 660 that are displayed on the computer monitor 658.

FIG. 6C depicts the generative content 674 as being visually rendered via the display 622 of the client device 610, however, this is not meant to be limiting. For example, the generative content can be audibly rendered via one or more speakers of the client device 610, or another computing device. Additionally and/or alternatively, the generative content 610 can be rendered visually via a display of an additional computing device.

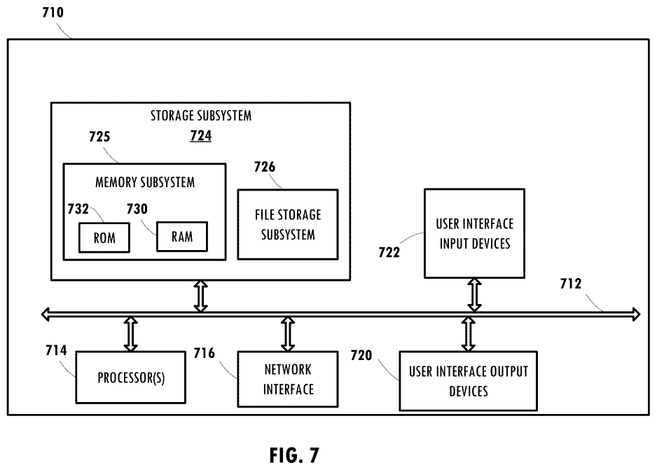

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform selected aspects of methods disclosed herein, and/or to implement one or more aspects of the various components depicted in FIG. 1. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a CD-ROM drive, an optical drive, or removable media cartridges. Modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple buses.

Computer system 710 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

In some implementations, a method implemented by processor(s) is provided and includes receiving a request including image data corresponding to an image including one or more objects in an environment. The method also includes determining, based on the image data, that a particular object of the one or more objects has one or more particular features and/or has a particular classification. In response to determining the particular object has one or more of the particular features and/or has the particular classification, the method includes generating updated image data including generating the updated image data to exclude the particular object. The method includes providing the updated image data to one or more image analysis modules including one or more image analysis modules configured to process the updated image data to generate textual output representative of one or more of the objects included in the updated image data. The method includes receiving, in response to providing the updated image data to one or more of the image analysis modules and from one or more of the image analysis modules, the textual output. The method includes generating, based on the textual output received from one or more of the image analysis modules, an input prompt for a generative model. The method includes providing the input prompt to the generative model including causing processing of the input prompt using the generative model. The method includes receiving, in response to providing the input prompt, generative content generated based on processing the input prompt using the generative model. The method includes causing the generative content to be provided responsive to the request.

In some implementations, the method can further include filtering the textual output from one or more image analysis modules to remove descriptions of objects having one or more particular features and/or a having particular classification prior to generating the input prompt. In some versions of those implementations, filtering the textual output from one or more of the image analysis modules can cause the input prompt to be generated without one or more of the descriptions of the one or more objects having one or more of the particular features and/or having the particular classification. In some versions of those implementations, filtering the textual output from one or more of the image analysis modules to remove one or more of the descriptions of the one or more objects having one or more of the particular features and/or having the particular classification can further include providing, as input to an additional generative model, the textual output from one or more of the image analysis modules and an additional input prompt and an additional input prompt that can include instructions that cause one or more of the descriptions of the one or more objects having one or more of the particular features and/or having the particular classification to be removed.

In some implementations, generating the updated image data that excludes the particular object can further include obfuscating the one or more objects having one or more of the particular features and/or having the particular classification.

In some implementations, obfuscating the one or more objects having one or more of the particular features and/or having the particular classification can include altering one or more pixel values corresponding to color settings of pixels in the image data.

In some implementations, generating the updated image data that excludes the particular object can further include partitioning the image data into one or more image segments. A particular image segment of the one or more image segments can include the particular object having one or more of the particular features and/or having the particular classification. The method can further include excluding the particular image segment from the updated image data while including one or more other of the image segments. In some versions of those implementations, providing the updated image data to one or more image analysis modules can further include providing a subset of the one or more image segments to one or more of the image analysis modules. The subset of image segments can exclude the particular image segment that includes the particular object having one or more of the particular features and/or having the particular classification.

In some implementations, the input prompt can cause omission, in the generative content that is responsive to the user request, of any reference to the particular object having one or more of the particular features and/or having the particular classification.

In some implementations, a method implemented by processor(s) is provided and includes receiving a request including image data corresponding to an image including one or more objects in an environment. The method includes providing the image data to one or more image analysis modules that can be configured to process the image data to generate textual output representative of one or more of the objects included in the image data. The method includes receiving, in response to providing the image data to one or more of the image analysis modules and from one or more of the image analysis modules, the textual output. The method includes generating filtered textual output including generating the filtered textual output to exclude a portion of the textual output that is representative of one or more of the objects having one or more particular features and/or having a particular classification. The method includes generating, subsequent to generating the filtered textual output, an input prompt for a generative model based on the filtered textual output. The method includes providing the input prompt to the generative model including causing processing of the input prompt using the generative model. The method includes receiving, in response to providing the input prompt to the generative model, generative content that is generated based on processing the input prompt using the generative model and causing the generative content to be provided responsive to the request.

In some implementations, the input prompt can cause the generative content responsive to the user request to omit a reference to the one or more objects having one or more of the particular features and/or having the particular classification.

In some implementations, the image data corresponding to the image can be based on content being currently rendered at the computing device. In some versions of those implementations, the content being currently rendered at the computing device can be visual content.

In some implementations, a method implemented by processor(s) is provided and includes receiving a request including image data corresponding to an image including one or more objects in an environment. The method includes determining, based on the image data, that a particular object of the one or more objects has one or more particular features and/or has a particular classification. In response to determining the particular object has one or more of the particular features and/or has the particular classification, the method includes generating updated image data, including generating the updated image data to exclude the particular object. The method includes generating an input prompt for a generative model including the updated image data. The method includes providing the input prompt, including the updated image data, to the generative model and causing processing of the input prompt, including the updated image data, using the generative model. The method includes receiving, in response to providing the input prompt, including the updated image data, to the generative model, generative content generated based on processing the input prompt, including the updated image data, using the generative model. The method includes causing the generative content to be provided responsive to the request.

In some implementations, generating the updated image data that excludes the particular object can include obfuscating the one or more objects having one or more of the particular features and/or the particular classification. In some of those implementations, obfuscating the one or more objects having one or more of the particular features and/or having the particular classification can include altering one or more pixel values, the one or more pixel values corresponding to color settings of one or more pixels of the image data.

In some implementations, generating the updated image data that excludes the particular object can further include partitioning the image data into one or more image segments, a particular image segment of the one or more image segments including the particular object having one or more of the particular features and/or having the particular classification. In some of those implementations, the updated image data can exclude the particular image segment.

In some implementations, the input prompt can cause the generative content that is responsive to the user request to omit a reference to the particular object having one or more of the particular features and/or having the particular classification.

In some implementations, the image data corresponding to the image can be based on content currently being rendered at the computing device.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the methods disclosed herein. Some implementations include one or more computer-readable storage media (e.g., transitory and/or non-transitory) storing computer instructions executable by one or more processors to perform any of the methods disclosed herein. Some implementations include a computer program product including instructions executable by one or more processors to perform any of the disclosed herein.

We claim:

1. A method implemented by one or more processors, the method comprising:
receiving a request, wherein the request includes image data corresponding to an image that includes one or more objects in an environment;
determining, based on the image data, that a particular object of the one or more objects has one or more particular features and/or has a particular classification;
in response to determining the particular object has one or more of the particular features and/or has the particular classification, generating updated image data, wherein generating the updated image data comprises generating the updated image data to exclude the particular object;
providing the updated image data to one or more image analysis modules, wherein one or more of the image analysis modules are configured to process the updated image data to generate textual output that is representative of one or more of the objects included in the updated image data;
receiving, in response to providing the updated image data to one or more of the image analysis modules and from one or more of the image analysis modules, the textual output;
generating, based on the textual output received from one or more of the image analysis modules, an input prompt for a generative model;
providing the input prompt to the generative model, wherein providing the input prompt to the generative model causes processing of the input prompt using the generative model;
receiving, in response to providing the input prompt, generative content that is generated based on processing the input prompt using the generative model; and
causing the generative content to be provided responsive to the request.

2. The method of claim 1, further comprising:
prior to generating the input prompt, filtering the textual output from one or more of the image analysis modules to remove one or more descriptions of the one or more objects having one or more of the particular features and/or having the particular classification.

3. The method of claim 2, wherein filtering the textual output from one or more of the image analysis modules causes the input prompt to be generated without the one or more descriptions of the one or more objects having one or more of the particular features and/or having the particular classification.

4. The method of claim 2, wherein filtering the textual output from one or more of the image analysis modules to remove one or more of the descriptions of the one or more objects having one or more of the particular features and/or having the particular classification comprises:
providing, as input to an additional generative model:
the textual output from one or more of the image analysis modules; and
an additional input prompt, wherein the additional input prompt, wherein the additional input prompt includes instructions that cause one or more of the descriptions of the one or more objects having one more of the particular features and/or having the particular classification to be removed.

5. The method of claim 1, wherein generating the updated image data that excludes the particular object further comprises:
obfuscating the one or more objects having one or more of the particular features and/or having the particular classification.

6. The method of claim 1, wherein obfuscating the one or more objects having one or more of the particular features and/or having the particular classification comprises:
altering one or more pixel values, wherein the one or more pixel values correspond to color settings of one or more pixels of the image data.

7. The method of claim 1, wherein generating the updated image data that excludes the particular object further comprises:
partitioning the image data into one or more image segments, wherein a particular image segment of the one or more image segments includes the particular object having one or more of the particular features and/or having the particular classification; and
excluding, from the updated image data, the particular image segment while including one or more other of the image segments.

8. The method of claim 7, wherein providing the updated image data to one or more of the image analysis modules further comprises:
providing a subset of the one or more image segments to one or more of the image analysis modules, wherein the subset of the one or more image segments excludes the particular image segment that includes the particular object having one or more of the particular features and/or having the particular classification.

9. The method of claim 1, wherein the input prompt causes omission, in the generative content that is responsive to the user request, of any reference to the particular object having one or more of the particular features and/or having the particular classification.

10. A method implemented by one or more processors, the method comprising:
receiving a request, wherein the request includes image data corresponding to an image that includes one or more objects in an environment;
providing the image data to one or more image analysis modules, wherein one or more of the image analysis modules are configured to process the image data to generate textual output that is representative of one or more of the objects included in the image data;
receiving, in response to providing the image data to one or more of the image analysis modules and from one or more of the image analysis modules, the textual output;
generating filtered textual output, wherein generating the filtered textual output comprises generating the filtered the textual output to exclude a portion of the textual output that is representative of one or more of the objects having one or more particular features and/or having a particular classification;
generating, subsequent to generating the filtered textual output, an input prompt for a generative model based on the filtered textual output;
providing the input prompt to the generative model, wherein providing the input prompt to the generative model causes processing of the input prompt using the generative model;
receiving, in response to providing the input prompt to the generative model, generative content that is generated based on processing the input prompt using the generative model; and
causing the generative content to be provided responsive to the request.

11. The method of claim 10, wherein the input prompt causes the generative content that is responsive to the user request to omit a reference to the one or more objects having one or more of the particular features and/or having the particular classification.

12. The method of claim 10, wherein the image data corresponding to the image is based on content being currently rendered at the computing device.

13. The method of claim 12, wherein the content being currently rendered at the computing device is visual content.

14. A method implemented by one or more processors, the method comprising:
receiving a request, wherein the request includes image data corresponding to an image that includes one or more objects in an environment;
determining, based on the image data, that a particular object of the one or more objects has one or more particular features and/or has a particular classification;
in response to determining the particular object has one or more of the particular features and/or has the particular classification, generating updated image data, wherein generating the updated image data comprises generating the updated image data to exclude the particular object;
generating an input prompt for a generative model, wherein the input prompt includes the updated image data;
providing the input prompt, including the updated image data, to the generative model, wherein providing the input prompt, including the updated image data, to the generative model causes processing of the input prompt, including the updated image data, using the generative model;
receiving, in response to providing the input prompt, including the updated image data, to the generative model, generative content that is generated based on processing the input prompt, including the updated image data, using the generative model; and
causing the generative content to be provided responsive to the request.

15. The method of claim 14, wherein generating the updated image data that excludes the particular object comprises:
obfuscating the one or more objects having one or more of the particular features and/or having the particular classification.

16. The method of claim 15, wherein obfuscating the one or more objects having one or more of the particular features and/or having the particular classification comprises:
altering one or more pixel values, wherein the one or more pixel values correspond to color settings of one or more pixels of the image data.

17. The method of claim 14, wherein generating the updated image data that excludes the particular object further comprises:
partitioning the image data into one or more image segments, wherein a particular image segment of the one or more image segments includes the particular object having one or more of the particular features and/or having the particular classification.

18. The method of claim 17, wherein the updated image data excludes the particular image segment.

19. The method of claim 14, wherein the input prompt causes the generative content that is responsive to the user request to omit a reference to the particular object having one or more of the particular features and/or having the particular classification.

20. The method of claim 14, wherein the image data corresponding to the image is based on content currently being rendered at the computing device.
